(19) United States
(12) Patent Application Publication
(10) Pub. No.: US 2002/0035429 A1
(43) Pub. Date: Mar. 21, 2002

(54) Wireless reprogramming of vehicle electronic control units

(76) Inventor: Patrick A. Banas, Sterling Heights, MI (US)

Correspondence Address: LAURA M. SLENZAK, SIEMENS CORPORATION, 186 WOOD AVENUE SOUTH, ISELIN, NJ, 08830, US

(21) Appl. No.: 09/916,013

(22) Filed: Jul. 26, 2001

Related U.S. Application Data
(60) Provisional application No. 60/262,684, filed on Aug. 2, 2000.

(51) Int. Cl. G06F 19/00; G06G 7/70

(52) U.S. Cl. 701/115; 701/102

(57) ABSTRACT

A vehicle electronic control system includes a processor, a reprogrammable memory, and a wireless receiver. The reprogrammable memory includes an EEPROM, flash non-volatile memory, and/or other memory which can be reprogrammed to remotely upgrade instruction sets, such as configuration data, operational instructions, or the like which control vehicle performance. These upgrades are remotely achieved by wirelessly transmitting an updated instruction set to the reprogrammable memory through the receiver. The updated instruction set replaces the previous instruction set currently programmed in the reprogrammable memory, such that vehicle performance is improved.

### BACKGROUND OF THE INVENTION

The present application claims priority to U.S. Provisional Patent Application Ser. No. 60/262,864, filed Aug. 2, 2000.

The present invention relates to an electronic control unit, and more particularly to an electronic control unit which is remotely reprogrammable.

A vehicle electronic control unit (ECU) operates to control a vehicle engine and other subsystems to optimize vehicle performance in response to a multiple of inputs. In some instances, the ECU must be reprogrammed with updated configuration data, software upgrades, or the like to improve vehicle performance. Typically, the vehicle is returned to a service center and the updated instruction sets are downloaded to the ECU via a wire based electrical connection. In other vehicles ECU systems, a memory chip is completely replaced within the ECU. In either instance, the vehicle must be physically present at the repair location to effect the update since each vehicle must be individually connected to the host reprogramming system containing the updated instructions. This is time consuming and inefficient.

Accordingly, it is desirable to provide a vehicle ECU with the most recent configuration data, software upgrades, or like without actually having to physically communicate with the ECU. It is further desirable that the vehicle need not be physically returned to a repair facility to effect the update.

### SUMMARY OF THE INVENTION

The electronic control system according to the present invention includes a processor, a reprogrammable memory, an input interface, an output interface, and a receiver. The processor communicates with the reprogrammable memory to obtain inputs from a multiple of sensors and an instruction set preprogrammed into the reprogrammable memory to compute control signals for vehicle systems.

The reprogrammable memory includes an EEPROM, flash non-volatile memory, and/or other memory which can be reprogrammed. In many instances it is desirable to upgrade the instruction sets, such as configuration data, operational instructions, or the like which control vehicle performance. These upgrades are remotely achieved by wirelessly transmitting an updated instruction set to the reprogrammable memory through the receiver. The updated instruction set therefore replaces the previous instruction set current programmed in the reprogrammable memory.

In one embodiment, the receiver communicates with a reprogramming unit that transmits the updated instruction set through a wireless communication system such as a cellular base station, a space based system, a radio frequency system, or other wireless transmission system. In another embodiment, a relatively shorter range wireless transmitter such as an infrared transmitter communicates with the receiver such that a repair technician in rather close proximity to the vehicle remotely transmits an updated instruction set to the reprogrammable memory.

The present invention therefore provides a vehicle ECU with the most recent configuration data, software upgrades, or like without actually having to physically connect with the ECU.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general block diagram of a vehicle electronic control unit designed according to the present invention;

FIG. 2A is one embodiment of a wireless transmission system for use with the electronic control system of FIG. 1; and

FIG. 2B is another embodiment of a wireless transmission system for use with the electronic control system of FIG. 1.

### DETAILED DESCRIPTION OF THE PREFERRED EMBODIMENT

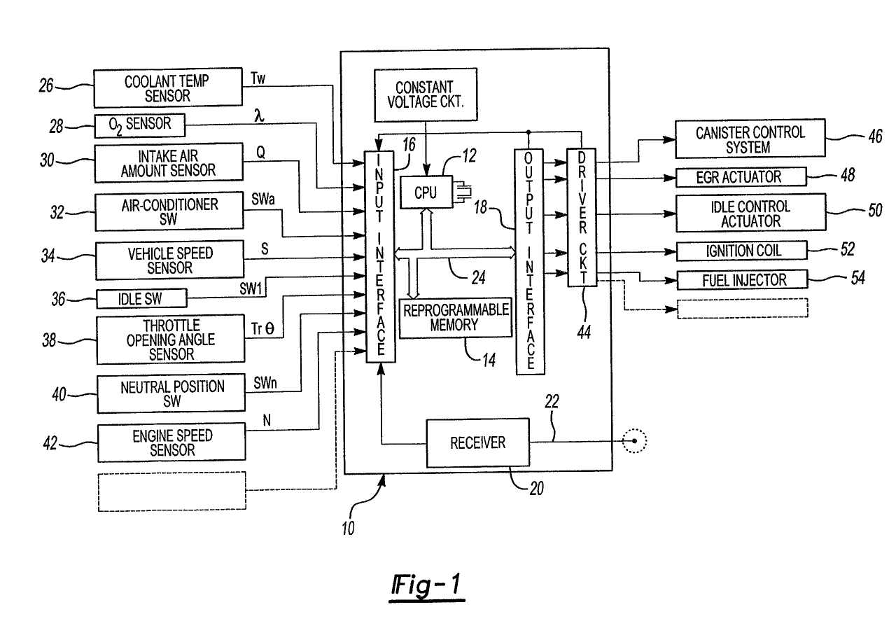

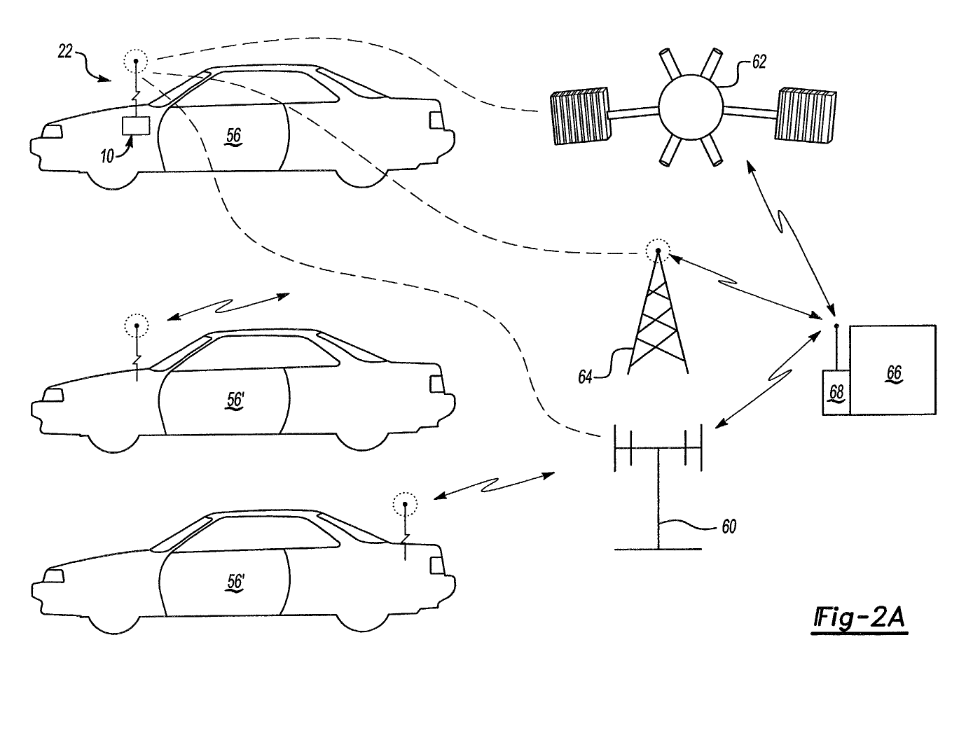

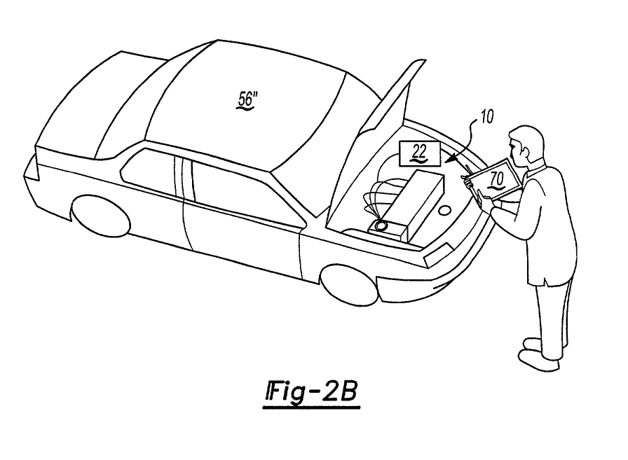

FIG. 1 illustrates an electronic control system 10 for a vehicle 12 (FIG. 2). The system 10 generally includes a processor 12, a reprogrammable memory 14, an input interface 16, an output interface 18, and a receiver 20 having an antenna 22. Each component preferably communicates with each other over a bus 24 or the like. It should be understood that although a bus-based system is disclosed in the illustrated embodiment, arrangement such as integrated circuits will also benefit from the present invention.

Data inputted via the input interface 16 includes for example only, are a coolant temperature signal T.sub.W detected by a coolant temperature sensor 26, a lean/rich signal .lambda. of the air-fuel ratio detected by an O.sub.2 sensor 28, an intake air amount signal Q measured by an intake air amount sensor 30, an ON/OFF signal SW.sub.a of an air-conditioner switch 32, a vehicle speed signal S detected by a vehicle speed sensor 34, an ON/OFF signal SW.sub.I of an idling switch 36, a throttle opening angle signal Tr.theta. detected by a throttle opening angle sensor 38, an ON/OFF signal SW.sub.n of a neutral position switch 40, an engine speed signal N detected by an engine speed sensor 42 and he like. It should be understood that although particular sensors commonly associated with an engine control unit are disclosed in the illustrated embodiment, other sensors and other vehicle control units will benefit from the present invention. It should be understood that other devices will also benefit from the present invention.

The inputs are preferably temporarily stored in the reprogrammable memory 14 for use with the calculation of control variables. That is, the processor 12 determines control variables such as a fuel injection pulse width, an ignition timing and the like. In response to the inputs, control signals corresponding to these control variables are outputted from the output interface 18 to a driver circuit 44 at a specified timing. Preferably, instruction sets, such as configuration data, operational instructions, or the like which control vehicle performance in association with inputs from the vehicle sensors are also stored within the reprogrammable memory 14. The processor 12 communicates with the reprogrammable memory 14 to obtain inputs from the sensors and then uses the instruction sets preprogrammed into the reprogrammable memory 14 to compute the control signals.

The control signals from the processor 12 are transformed into driver signals in the driver circuit 44. The driver signals are outputted to various vehicle systems such as for example only, a canister control system 46, an EGR actuator 48 for controlling an EGR amount, an idling control actuator 50 for controlling an idling speed, an ignition coil 52 for energizing an ignition signal on a spark plug, a fuel injector 54 for metering and injecting a specified amount of fuel and other device to control the engine at an optimum condition in any operational area. It should be understood that although particular systems commonly associated with engine control units are disclosed in the illustrated embodiment, other sensors and other vehicle control units will benefit from the present invention.

Preferably, the reprogrammable memory 14 includes an EEPROM, flash non-volatile memory, and/or other memory which can be reprogrammed. In many instances it is desirable to upgrade the instruction sets, such as configuration data, operational instructions, or the like which control vehicle performance. Preferably, these upgrades are remotely achieved by sending an updated instruction set to the reprogrammable memory 14 through the receiver 20. The updated instruction set therefore replaces the previous instruction set current programmed in the reprogrammable memory 14.

Referring to FIG. 2A, the antenna 22 may be a preexisting antenna 22 used by a vehicle 56 to receive signals from a cellular base station (illustrated schematically at 60), a space based system (illustrated schematically at 62), a radio frequency system (illustrated schematically at 64), or other wireless transmission system. Additionally, or in the alternative, the ECU 10 may further include a dedicated antenna for communication with one or more wireless transmission systems.

A reprogramming unit 66 includes a transmitter 68 to transmit the updated instruction set through the desired wireless communication system 60,62,64. The vehicle 56 may thus be remotely located from the reprogramming unit 66 while the upgrade actually takes place. A multiple of vehicles 56′ may thus be simultaneously upgraded by transmitting the updated instruction set through a known wireless transmission system. As each receiver 20 (FIG. 1) preferably includes its own unique identification, only those vehicles which are identified by the reprogramming unit 66 will actually be upgraded. In other words, for example only, only a certain vehicle type, having a certain engine, and produced during a certain time period will be updated.

Referring to FIG. 2B, a repair facility reprogramming unit 70 includes a wireless transmitter such as an infrared transmitter 72 such that a repair technician in rather close proximity to the vehicle remotely transmits an updated instruction set to the reprogrammable memory 14 through the receiver 20 (FIG. 1). Although the vehicle 56 is actually within a repair facility, a repair technician need not actually physically link to the connect the reprogrammable memory 14. Updates are thus more rapidly achieved without the complexity of physical connections.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An electronic control system for a vehicle comprising:
a processor for executing a set of instructions;
a reprogrammable storage device communicating with said processor, said reprogrammable storage device containing a first set of instructions for execution by said processor; and
a receiver communicating with said reprogrammable storage device, said receiver operable to selectively communicate with a wireless transmission system to receive a second set of instructions for execution by said processor, said second set of instructions replacing said first set of instructions.

2. The system as recited in claim 1, wherein said reprogrammable storage device includes an EEPROM.

3. The system as recited in claim 1, wherein said reprogrammable storage device includes a flash non-volatile memory.

4. The system as recited in claim 1, wherein said receiver communicates via a cellular system.

5. The system as recited in claim 1, wherein said receiver communicates via an infrared system.

6. The system as recited in claim 1, wherein said receiver communicates via a radio frequency system.

7. The system as recited in claim 1, wherein said processor communicates with a vehicle engine.

8. A method of reprogramming a vehicle electronic control unit for control of a vehicle engine comprising the steps of:
(1) wirelessly transmitting a second set of instructions executable by a vehicle electronic control unit;
(2) receiving the second set of instructions at a vehicle electronic control unit; and
(3) replacing a first set of instructions stored in the vehicle electronic control unit with the second set of instructions such that the vehicle electronic control unit executes the second set of instructions.

9. A method as recited in claim 8, wherein said step (1) includes transmitting the second set of instructions through a space based system.

10. A method as recited in claim 8, wherein said step (1) includes transmitting the second set of instructions through a cellular system.

11. A method as recited in claim 8, wherein said step (1) includes electromagnetically transmitting the second set of instructions.

12. A method as recited in claim 8, wherein said step (1) includes transmitting the second set of instructions through a radio frequency system.

13. A method as recited in claim 8, wherein said step (1) includes transmitting the second set of instructions through an infrared system.

14. A method as recited in claim 8, wherein said step (3) includes reprogramming a memory device of the vehicle electronic control unit.

15. A method as recited in claim 14, wherein said step (3) includes flash programming the memory device.

16. A method as recited in claim 8, wherein said step (1) includes substantially simultaneously transmitting the second set of instructions to a plurality of the vehicle electronic control unit.
